(19) United States
(12) Patent Application Publication
(10) Pub. No.: US 2025/0184239 A1
(43) Pub. Date: Jun. 5, 2025

(54) NETWORK NODE AND METHOD THEREIN

(71) Applicant: Telefonaktiebolaget LM Ericsson (publ), Stockholm (SE)

(72) Inventors: Ajay KATTEPUR, Bangalore (IN); Bikramjit SINGH, Kirkkonummi (FI); Ali BEHRAVAN, Stockholm (SE); Mohamed IBRAHIM, Aachen (DE); Erik NORDELL, Danderyd (SE)

(21) Appl. No.: 18/842,880

(22) PCT Filed: Mar. 8, 2022
(86) PCT No.: PCT/SE2022/050228

§ 371 Date: Aug. 30, 2024

(51) Int. Cl. H04L 41/5009; H04L 41/16; H04W 28/02; H04W 64/00

(52) U.S. Cl. CPC H04L 41/5009; H04L 41/16; H04W 28/0268; H04W 64/00

(57) ABSTRACT

A method performed by a network node for handling operation of a User Equipment (UE) in a wireless communications network. The method includes obtaining a first value of a quality of service (QoS) characteristic for a service that is associated with a task performed by the UE, obtaining a set of second values of the QoS characteristic for the service, using the obtained set of second values and the obtained first value in a machine learning, e.g. reinforcement learning, model to determine a value of an operating parameter of the UE for performance of the task by the UE, and transmitting an indication of the determined value of the operating parameter for controlling operation of the UE in the wireless communications network based on the determined value of the operating parameter.

### TECHNICAL FIELD

Embodiments herein relate to a network node and a method therein. Furthermore, a computer program and a carrier are also provided herein. In some aspects, embodiments relate to handling operation of a UE while maintaining required quality of service (QoS) for the UE in a wireless communications network.

### BACKGROUND

In a typical wireless communications network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part, and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNodeB (gNB) as denoted in Fifth Generation (5G) telecommunications. A service area or cell area is a geographical area or indoor area where radio coverage is provided by the radio network node. The radio network node communicates over an air interface operating on radio frequencies with the wireless device within range of the radio network node.

The 3rd Generation Partnership Project (3GPP) is the standardization body for specify the standards for the cellular system evolution, e.g., including 3G, 4G, 5G and the future evolutions. Specifications for the Evolved Packet System (EPS), also called a Fourth Generation (4G) network, have been completed within the 3GPP. As a continued network evolution, the new releases of 3GPP specify a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but they have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as a UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques are used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

The 5G technology allows creating manufacturing factories and other facilities that can encompass automated robots, drones, transportation devices, and various other devices. Such characteristics of a 5G network as low latency, high reliability, high bandwidth, and connection density may be utilized to deploy autonomous or semi-autonomous 5G-enabled equipment in various settings.

A safe, proper, and efficient operation of an industrial factory or another facility, e.g., in manufacturing, process, and other industries employing automation requires accurate monitoring and control of devices in that facility. To ensure proper remote monitoring and control, which may be referred to as teleoperation, a QoS is required to be maintained for a UE, such as a UE comprising or being associated with a robot, vehicle, or another device performing a task. For example, in a 5G wireless communications network, it is desirable to maintain a 5G QoS Identifier (5QI) value assigned to a service. However, maintaining QoS for a device, particularly in a complex, dynamic environment where multiple devices may move and interact, is a complex task due to interference from other devices, positioning errors of the device, dependencies on other devices, and network conditions such as, e.g., wireless signal strength, latency, congestion, bandwidth, etc.

### SUMMARY

An object of embodiments herein is to improve handling operation of a UE in a wireless communications network so that a required QoS is maintained for a service related to a task for performance by the UE. Embodiments of the present disclosure relate to programming the UE and/or controlling the UE dynamically, to determine one or more of a location for the UE to operate in, a duration of time at the location, and resources for use by the UE in the wireless communications network, for performance of a task by the UE. The UE may comprise or may be associated with an autonomous or a semi-autonomous robot, which may be remote-controlled. In some embodiments, the UE may comprise or may be associated with any suitable 5G-enabled device.

According to an aspect of embodiments herein, the object is achieved by a method performed by a network node for handling operation of a UE in a wireless communications network. The network node obtains a first value of a QoS characteristic for a service that is associated with a task performed by the UE, and further obtains a set of second values of the QoS characteristic for the service. The network node further uses the obtained set of second values and the obtained first value in a machine learning model to determine a value of an operating parameter of the UE for performance of the task by the UE, and transmits an indication of the determined value of the operating parameter for controlling operation of the UE in the wireless communications network based on the determined value of the operating parameter.

According to an aspect of embodiments herein, the object is achieved by a network node for handling operation of a UE in a wireless communications network. The network node is configured to:
obtain a first value of a quality of service, QoS, characteristic for a service that is associated with a task performed by the UE;
obtain a set of second values of the QoS characteristic for the service;
use the obtained set of second values and the obtained first value in a machine learning model to determine a value of an operating parameter of the UE for performance of the task by the UE; and
transmit an indication of the determined value of the operating parameter for controlling operation of the UE in the wireless communications network based on the determined value of the operating parameter.

It is furthermore provided herein a computer program comprising instructions, which, when executed by at least one processor, cause the at least one processor to perform any of the methods in accordance with embodiments herein. It is additionally provided herein a carrier comprising the computer program, wherein the carrier is one of an electronic signal, an optical signal, an electromagnetic signal, a magnetic signal, an electric signal, a radio signal, a microwave signal, or a computer-readable storage medium.

Embodiments of the present disclosure relate to programming the UE and/or controlling the UE dynamically, to determine one or more of: a location for the UE to operate in, a duration of time at the location, and resources to be used by the UE in the wireless communications network, for performance of a task by the UE. The UE may comprise or may be associated with an autonomous or a semi-autonomous robot, which may be remote-controlled. In some embodiments, the UE may comprise or may be associated with any suitable 5G-enabled device.

In embodiments of the present disclosure, a required value of a QoS characteristic for performance of a service by a UE and observed values of the QoS characteristic are used in a machine learning model, such as, e.g. in a reinforcement learning model, to determine whether the observed values are comparable to the required value of the QoS characteristic and thereby determine a value of an operating parameter of the UE for controlling the UE to perform the service in the wireless communications network at a performance level that is consistent with the required value of the QoS characteristic.

Thus, the UE may be controlled to perform a service using certain values of operating parameters that constrain the UE to spatial, temporary, beamforming, wireless carrier, channel, and other resources at which observed QoS characteristic values match, or are close to, the required QoS characteristic values. A location and resource to be used for performance of a service by the UE may thus be tailored to specific requirements of that service.

For example, movements of the UE may be restricted to certain geographical regions within the wireless communications network, if the present methods determine that a required QoS may be met at these geographical regions. As another example, additionally or alternatively, the UE may be instructed to operate using certain resources within the wireless communications network, if the present methods determine that usage of these resources allows the required QoS be met. In this way, the methods in accordance with the present disclosure allow maintaining a QoS that is required for proper performance of a service by the UE. Furthermore, in some embodiments, locations and/or resources are determined for multiple UEs in the wireless communications network, in a manner that allows avoiding collisions and scheduling conflicts. This results in an improved way of controlling operation of the UE in the wireless communications network, whereby overall performance, reliability, and safety of the wireless communications network may be improved. Furthermore, for manufacturing and other facilities encompassing UEs associated with, e.g. robotic devices or vehicles, productivity, costs of operation, and other metrics may be improved using the methods in accordance with the present disclosure. Thus, embodiments herein improve handling operation of a UE in a wireless communications network so that a required QoS is maintained for a service related to a task for performance by the UE.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a schematic block diagram illustrating an embodiment of handling operation of multiple UEs in a wireless communications network.

FIG. 3 is a flowchart depicting an embodiment of a method in a network node.

FIG. 4 is a diagram illustrating an embodiment of a method of handling operation of a UE in a wireless communications network.

FIGS. 5A and 5B are schematic block diagrams illustrating a network node according to embodiments herein.

FIG. 6 is a schematic block diagram illustrating a UE according to embodiments herein.

FIG. 7 is a schematic illustration of a telecommunication network connected via an intermediate network to a host computer.

FIG. 8 is a generalized block diagram of a host computer communicating via a base station with a user equipment over a partially wireless connection.

FIGS. 9, 10, 11, and 12 are flowcharts illustrating methods implemented in a communication system including a host computer, a base station and a user equipment.

### DETAILED DESCRIPTION

Example embodiments herein relate to methods and network nodes for handling operation of a UE in a wireless communications network by determining locations, resources, and values of other operating parameters for controlling operation of the UE, at which parameter values an observed QoS for a service meets a target QoS for that service.

In environments where multiple UEs comprising or associated with, e.g. mobile robots, operate to perform various tasks, accurate monitoring and control of the operation of the UEs and/or associated devices, also collectively referred to herein as UEs, may be essential for proper operation of a manufacturing, process, or other facility employing a wireless communications network. However, proper control of a UE comprising or associated with a robotic device may be challenging, due to interference from other devices and various obstacles in the facility, errors in positioning of the UE, variations in network conditions including traffic, changes of actors on the network and their activities, errors and inconsistencies in sensor measurements, dependency on operation of other devices during a task execution, etc. Furthermore, appropriate control of operation of the UE in a wireless communications network requires setting of QoS values that are required to be maintained even when the UE such as, e.g. a robotic device, moves to various locations within a facility or another environment employing the wireless communications network.

Embodiments herein provide a method for handling operation of a UE in the manner that ensures that the operation of the UE is constrained to locations, resources, or other operating parameter values that make it possible for the UE to perform a service with the QoS having a value that meets, i.e. is close to, a required QoS value for the service. Different services may require different values of a QoS characteristic. For example, a Mission Critical delay sensitive signaling (MC-PTT) service may be associated with a higher packet priority and a lower packet delay budget than a non-conversational video service which, in turn, may have a lower packet priority and a higher packet delay budget than a conversational voice service. Methods in accordance with present disclosure allow allocating resources, and identifying a geographical region and other constraints for UE operation in accordance with requirements of a specific service performed by the UE. For example, in some embodiments, one or more locations on a floor of a manufacturing, warehouse, or other automated facility may be associated with information on corresponding services that may or may not be performed, e.g., as part of one or more tasks, at those locations. As another example, additionally or alternatively, resources, e.g. channel, spatial, beamforming resources, etc., at an automated facility may be associated with information on corresponding services that may or may not be performed using those resources. In this way, traffic in the wireless communications network can be managed efficiently, in accordance with different QoS requirements of various services.

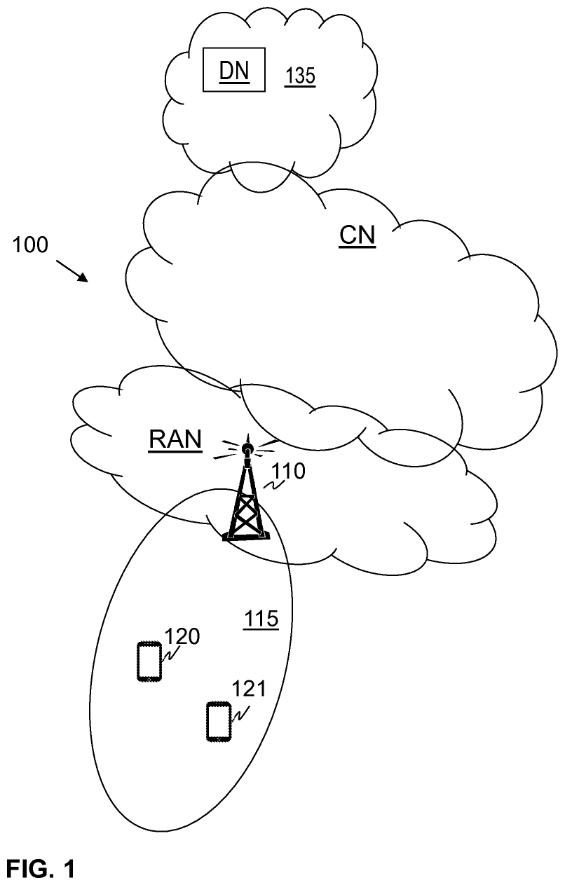

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a network node 110. The network node 110 provides radio coverage in a cell which may also be referred to as a beam or a beam group of beams, such as a cell 115 provided by the network node 110.

The network node 110 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE within the service area served by the network node 110 depending e.g. on the first radio access technology and terminology used. The network node 110 may communicate with one or more UEs in the wireless communications network 100 in Downlink (DL) transmissions to the respective UE and Uplink (UL) transmissions from the respective UE.

A number of UEs operate in the wireless communications network 100, such as, e.g., a UE 120 and one or more other UEs 121. Each of the UEs may also be referred to as an autonomous or semi-autonomous robotic device, a robot, a device, an IoT device, a mobile station, a non-access point (non-AP) STA, a STA, a user equipment and/or a wireless terminal, communicate via one or more Access Networks (AN), e.g. RAN, to one or more core networks (CN). It should be understood by the skilled in the art that a “UE” is a non-limiting term and it means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

In various embodiments, the wireless communications network 100, which may be a private network, comprises a system or facility comprising one or more autonomous or semi-autonomous robotic devices or robots. The system may be, for example, a manufacturing factory, a warehouse, a harbour, a transportation facility, an airport facility, an oil platform, a power plant, a mine, a surveillance system which may employ drones, or any other suitable system or facility, or a combination thereof. In such embodiments, the UE 120 may be a fully or partially autonomous robot, a robot that operates in collaboration with a human, a drone, a transportation device, a smart tool, or any other suitable device that forms part of or is associated with the wireless communications network 100 and may communicate with other devices in the wireless communications network 100.

Methods herein may e.g. be performed by the network node 110. As an alternative, a Distributed Node (DN) and functionality, e.g. comprised in a cloud 135 as shown in FIG. 1, may be used for performing or partly performing the methods herein.

A number of embodiments will now be described, some of which may be seen as alternatives, while some may be used in combination.

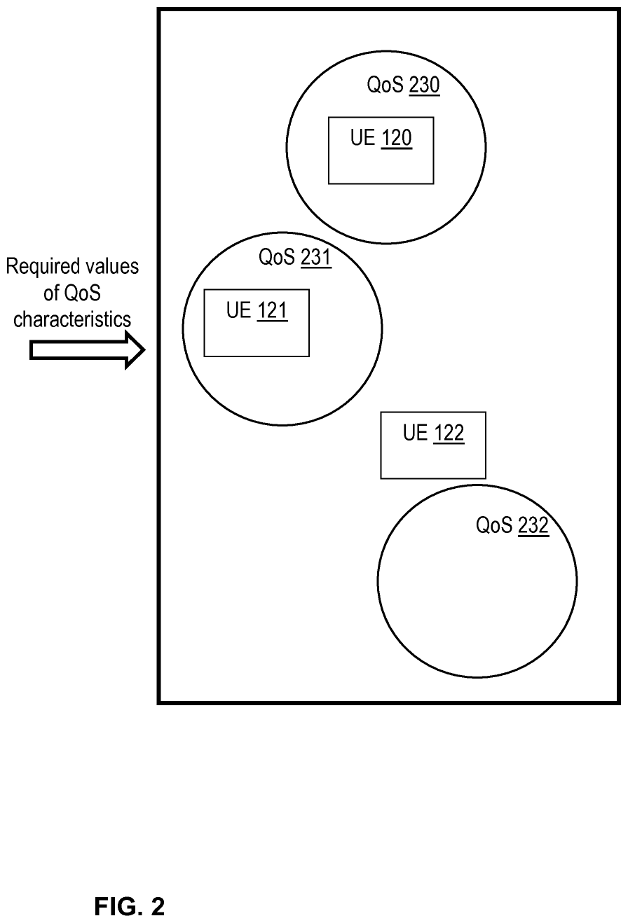

FIG. 2 illustrates an embodiment of UEs in the wireless communications network 100, which operation may be controlled using the method in accordance with embodiments herein. A required value of a QoS characteristic, referred to herein as a first value of a QoS characteristic, may be associated with a service associated with a task to be performed by the UE 120. It should be appreciated that QoS requirements for a service may be defined as values for one or more QoS characteristics, e.g., priority, packet loss, packet belay, bit rate guarantee, etc. As shown schematically in FIG. 2, UEs in the wireless communications network 100, such as UEs 120, 121, and 122, wherein a third UE 122 may be similar to e.g. the UE 120 or the other UE 121, may each be associated with a required value of a QoS characteristic. The required value of the QoS characteristic may be assigned to a service associated with a task to be performed by a UE. For example, a conversational voice service may be associated with a Guaranteed Bit Rate (GBR) resource type, a number of priority levels, packet delay budget, packet error rate, max data burst volume, and averaging window.

During operation of the UE 120 in the wireless communications network 100, observed QoS values may deteriorate relative to their required counterparts for various reasons, such as, e.g. changes in the UE position, bursty traffic arrival, a task time period, change in network conditions, etc. Accordingly, in embodiments herein, locations, duration of time at those locations, resources, and other operating parameter values may be determined for the UE 120 in the wireless communications network, more specifically, for a task to be performed by the UE 120. It should be appreciated that the task to be carried out by the UE may be associated or may comprise one or more services, e.g., video, voice, automation, and other services that are performed as part of the task performance. The task may rely on one or more services, and some or all of the services may have different QoS requirements. A tasks may last longer than services it relies on, and the task may, for example, have service chain associated therewith. In some embodiments, a task may ay require communication, application, and/or other services. It should be appreciated that embodiments herein are not limited to any specific tasks or services. It should also be appreciated that the UE 120 may not itself perform a task. Rather, as mentioned above, in some embodiments, the UE 120 may be associated with a device, such as, e.g., a robotic device, vehicle, other equipment, or sensors and other devices configured to perform the task. Furthermore, a task may be performed by more than device. For the purposes of the present disclosure, however, the UE 120 is described as performing a task and associated one or more services associated with that task.

Referring back to FIG. 2, for each of the UEs 120, 121, and 122, a certain location may be determined at which observed values of a QoS characteristic for the service meet the required value of that QoS characteristic. For simplicity, it is assumed that values of the QoS characteristic are monitored for the same service performed by the UEs 120, 121, and 122, but it should be appreciated that each of the UEs 120, 121, and 122 may perform more than one of the same or different services. As shown in FIG. 2, regions, depicted as QoS regions, 230, 231, and 232 are determined for the UEs 120, 121, and 122, respectively. As shown in this example, the UE 120 is located in the region 230 where observed values of the QoS characteristic meet the required value of the QoS characteristic, and the other UE 121 is similarly located in the region 231 where observed values of the QoS characteristic meet the required value of the QoS characteristic. It should be noted that a location or region in the wireless communications network may be suitable for performance of one or more services by one or more UEs. As also shown in FIG. 2, the third UE 122 is located outside the region 232 at which observed values of the QoS characteristic meet the required value of the QoS characteristic. Accordingly, a method in accordance with some embodiments, performed by the network node 110, may determine that a current location of the third UE 122 is not appropriate for performance of the service, and it may be determined that, to perform the service with the required QoS, the third UE 122 needs to be instructed to move to the region 232 at which observed values of the QoS characteristic are close or closer to the required, target QoS value.

The method for handling operation of the UE 120 and/or other UEs in the wireless communications network 100 may be performed in the network node 110, which may be, e.g., a base station such as a gNodeB (gNB). The network node 110 includes a reinforcement learning (RL) agent to determine an operating parameter for the UE, which may be implemented in software, hardware, or combinations thereof. In some embodiments, the RL agent may be implemented as computer-executable instructions for execution by a processor included in or associated with the network node 110.

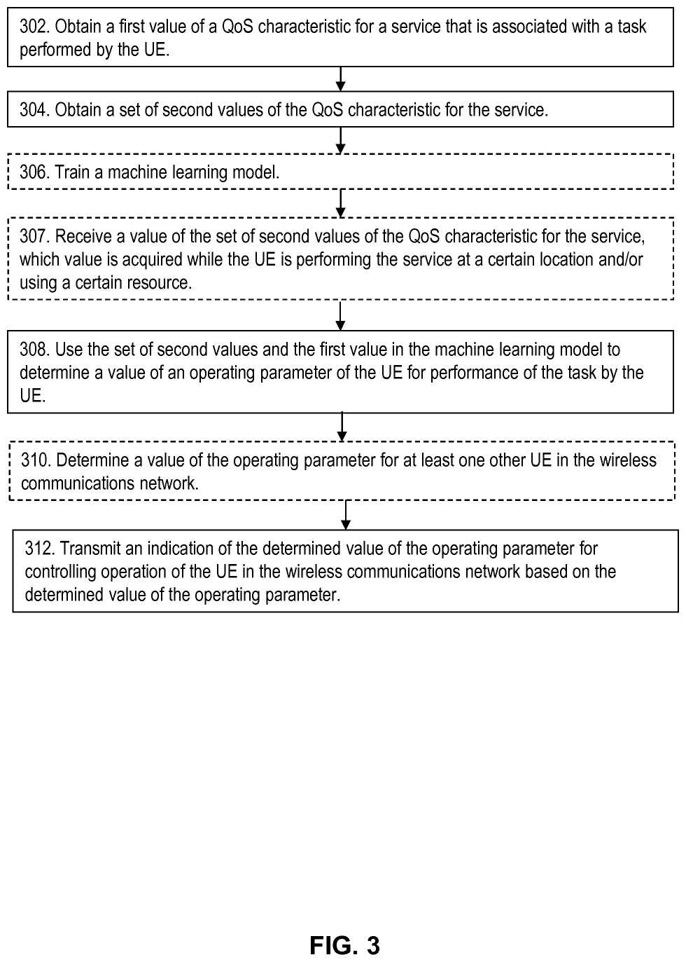

FIG. 3 shows example embodiments of the method performed by the network node 110 for handling operation of the UE 120 in the wireless communications network 100.

The method comprises the following actions, which actions may be taken in any suitable order. Optional actions are referred to as dashed boxes in FIG. 3.

### Action 302

The network node 110 obtains a first value of a QoS characteristic for a service that is associated with a task performed by the UE 120.

In some embodiments, the first value of a QoS characteristic is a required, or target, value for the QoS characteristic, also referred to herein as a target QoS. In some embodiments, the first value of the QoS characteristic is assigned to each service that is included in the task that the UE 120 is configured to perform. Thus, a service may be associated with values of one or more QoS characteristics, which values are desired to be maintained as the service is implemented by the UE 120.

In some embodiments, the first value, which may comprise one or more values, may be associated with a QoS identifier. For example, in the context of a 5G network, the first value of the QoS characteristic may comprise a 5G QoS identifier, referred to as a 5QI, or value(s) of one or more QoS characteristics associated with the 5QI identifier. The 5QI is often referred to as a pointer to associated values of QoS characteristics, which may be standardized. The QoS for 5G NR may be based on QoS flows, defined in 3GPP TS 23.501, and supports GBR (guaranteed flow bit rate, guaranteed throughput) and Non-GBR (not guaranteed flow bit rate, not guaranteed throughput). QoS flows are characterized by a priority value that determines the packet delay budget, packet loss and bit rates.

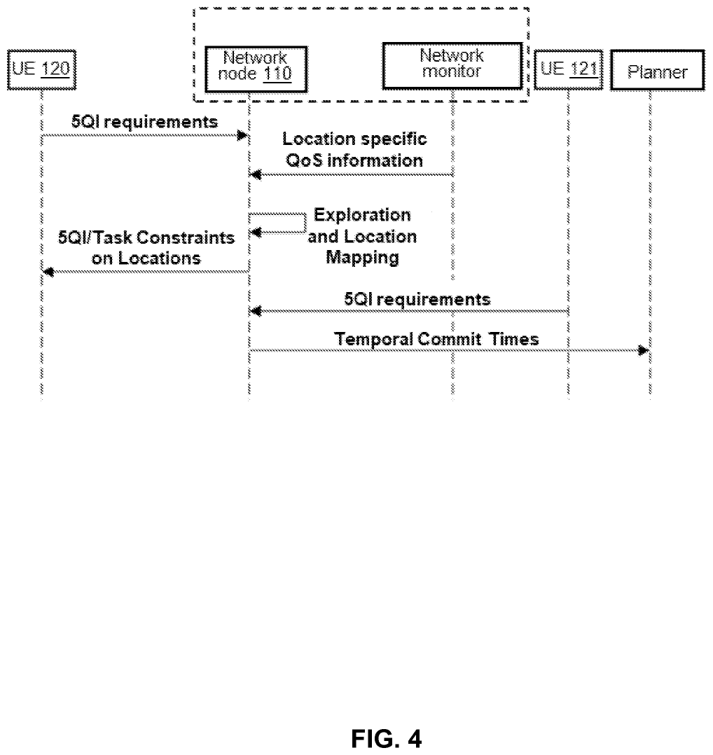

The first value of the QoS characteristic for the service may be obtained from the UE 120, as shown in FIG. 4, discussed below. In some embodiments, e.g., when the network node 110 is or comprises a base station, the network node 110 may be aware of the first value of the QoS characteristic for the UE 120 and of similar required QoS characteristic values for other UEs serviced by the base station. In some embodiments, each service performed, currently or in the future, by a UE such as, e.g., the UE 120, is associated with a first value of the QoS characteristic.

In some embodiments, the QoS characteristic comprises one or more out of a packet priority, a packet error rate, a packet delay, a bit rate guarantee, an applied periodicity, an allowed data for a packet, a packet delay variation, a minimum burst value, a maximum burst value, an average burst value, n-th delay moment, n-th moment of arrival rate, packet arrival distribution, delay variance, arrival variance, and packet volume distribution. The first value of the QoS characteristic may comprise one or more values of any one or more out of the above QoS characteristics, or other QoS characteristics. Any suitable QoS characteristics, which may be standardized or not, may be used additionally or alternatively in connection with a service.

Furthermore, in some embodiments, in addition to the first value of the QoS characteristic, which may be associated with an identifier such as, e.g. a 5QI, the network node 110 may also receive Time Sensitive Communications Assistance Information (TSCAI) from a Core Network. This may occur, e.g. during QoS flow establishment. In some embodiments, the TSCAI may be received from another network node, e.g. another gNB, during handover. TSCAI includes additional information about a traffic flow such as, e.g. burst arrival time and burst periodicity.

### Action 304

The network node 110 further obtains a set of second values of the QoS characteristic for the service that is associated with the task performed by the UE 120. The second values may comprise one or more second values. In some embodiments, the second values of the QoS characteristic may comprise observed values of the QoS characteristic, also referred to herein as an observed QoS. The set of second values of the QoS characteristic may be acquired, e.g. as the UE 120 performs the task in the actual operating environment, when the UE 120 is trained to perform the task e.g., via simulation, or both before the UE 120 performs the task and dynamically, as the UE 120 performs the task. For example, in some embodiments, the observed values may be obtained offline, as the UE 120 is being taught to move and/or otherwise function to perform a desired task comprising one or more services. This may be performed as part of planning of a UE's trajectory path and motion during performance of a task. Furthermore, in such cases, operation of the UE 120 may further be adjusted based on conditions of the real-life environment in which the UE 120 operates. For example, the network node 110 may acquire information from the UE 120 and/or from other entities in the network 100, on one or more of locations, resources and other properties of the wireless communications network 100 at which values of QoS characteristics may be below respective required values.

In some implementations, the observed QoS characteristic values may be acquired dynamically, in real time, i.e. as the UE 120 is performing the service in the wireless communications network 100. As an example, the UE 120, e.g., a robot associated with the UE 120, may perform an assembly task in a manufacturing facility, and related information may be acquired. The present method for handling operation of the UE 120 may be performed at any suitable time, as embodiments herein are not limited in this respect.

Furthermore, in some embodiments, the network node 110 may use a timing counter for determining when to recalculate one or more values of the set of second values of the QoS characteristic for the service. For example, the network node 110 may recalculate or obtain other instances of the one or more values of the set of second values of the QoS characteristic for a given resource or location when the timing counter expires. The timing counter, which may be adjustable, may be set such that one or more values of the set of second values of the QoS characteristic for the service are recalculated over equal time intervals. In some embodiments, one or more values of the set of second values of the QoS characteristic for the service may be recalculated for different times of day. Furthermore, in some embodiments, the values from the set of second values of the QoS characteristic may be recalculated or reacquired upon a change in a network traffic, a change in a number of UEs in the wireless communications network 100, or when other changes occur in the wireless communications network 100.

In embodiments of the present disclosure, a type of the obtained second values of the QoS characteristic for a service may correspond to the first value of the QoS characteristic for that service. The first and second values may be quantitative, qualitative, or combination(s) thereof.

Similar to the first value of the QoS characteristic, the set of second values of the QoS characteristic may comprise values of one or more out of a packet priority, a packet error rate, a packet delay, a bit rate guarantee, an applied periodicity, an allowed data for a packet, a packet delay variation, e.g. jitter, a minimum burst value, a maximum burst value, an average burst value, n-th delay moment, n-th moment of arrival rate, packet arrival distribution, delay variance, arrival variance, and packet volume distribution. Any other QoS characteristics may be used, as embodiments of the present disclosure are not limited in this respect.

In some embodiments, the second values of the QoS characteristic comprise one or more Key Performance Characteristics (KPI) for a service or a task. In some embodiments, KPIs may be domain-specific KPIs. For instance, in robotics applications, KPIs may comprise a rate of completion of tasks, tracking errors, etc. In larger manufacturing facilities, KPIs may comprise a production rate, and efficiency and throughput of processes. These KPIs may be indirectly affected by the 5QI settings. In some embodiments, additionally or alternatively, the second values of the QoS characteristic may comprise or may be derived from one or more out of a packet error rate (PER), bit error rate (BER), bit rate, collision rate, and other measurements.

### Action 306

In some embodiments herein, a machine learning model is used to determine one or more operating parameters of the UE 120 that allow the UE 120 maintain required, or close to required, QoS values for the service associated with the task performed by the UE 120. In some embodiments, the machine learning model comprises a reinforcement learning (RL) model.

Accordingly, in some embodiments, the network node 110 trains the RL model by applying a reinforcement learning algorithm to a set of states of the UE 120 and a set of actions of the UE 120 to be taken by the UE 120 to transition between states of the set of states. In such embodiments:
each state from the set of states of the UE 120 is associated with a corresponding operating parameter of the UE 120,
each action from the set of actions of the UE 120 is associated with a corresponding reward value, and
the reinforcement learning model may be trained to identify whether the UE 120 is to take an action from the set of actions of the UE 120 to be taken by the UE 120, to transition from a first state from the set of states of the UE 120 to a second state from the set of states of the UE 120 when an observed value for the QoS characteristic for the service at the second state is closer or closest to the first value of the QoS characteristic as compared to an observed value for the QoS characteristic for the service at the first state.

The network node 110, comprising e.g., an RL agent implemented and executed thereon, may train the RL model such that the RL model takes into consideration various values, including network conditions, available resources and locations, etc. The RL model is trained by exploring a space of possible states, to achieve a certain performance goal.

Accordingly, in some embodiments, the RL model is trained to determine whether the UE 120 is to transition from its current state to another state, or whether and for how long to remain in the current state, wherein the state defines the current status of the UE 120. The transition to another state may be instructed to achieve a higher QoS than a current QoS, where the higher QoS for a certain service may be a highest QoS possible given current circumstances, network properties, etc.

As used herein, one observed value for the QoS characteristic is determined to be closer to the first value of the QoS characteristic than another value for the QoS characteristic when a difference between the one observed value and the first value is smaller than a difference between the another observed value and the first value. As used herein, one observed value for the QoS characteristic is determined to be closest to the first value of the QoS characteristic than one or more other observed values for the QoS characteristic when a difference between the one observed value the first value is smaller than a difference between each of the one or more other observed values for the QoS characteristic. Accordingly, a transition from one, current state to another, next state may be considered valid when the next state allows achieving the highest possible QoS i.e. closest to the target QoS. Depending on various circumstances, a transition from one state to another state may also be considered valid when the next state allows achieving values of QoS that are closer to the target values of QoS than values of the QoS at the current state, even though the transition may not provide the highest possible QoS, but the transition is most appropriate given various factors, e.g. resource availability, obstacles, etc., and still allows achieving values of QoS that are comparable to the target values of QoS and that thus allow carrying out the service with desirable quality.

In some implementations, the RL model defines a transition from the first state to the second state when the second state permits maintaining or improving a current QoS. The transition may be recommended in the form of a value of the operating parameter that defines such transition (e.g. one or more of another location, a different resource, etc.).

In some embodiments, the RL model defines a transition from the first state to the second state when a difference between the observed value for the QoS characteristic at the second state and the first value of the QoS characteristic is smaller than a difference between the observed value for the QoS characteristic at the first state and the first value of the QoS characteristic.

The RL model may be implemented in various ways. In some embodiments, a model underlying the RL model is a Markov Decision Process (MDP). The MDP may be formulated for an agent with state space S, action space A, with Pₐ(s,s′) representing the probability of action a in state s leading to s′, and Rₐ(s,s′) providing the reward for transitioning from state s to state s′ due to action a. The RL model may be trained using, e.g., a Q-learning algorithm, a temporal difference learning, or another technique, or a combination thereof.

In some embodiments, a state of the set of states of the UE 120 comprises one or more of: the location of the UE 120 in the wireless communications network 100, a duration of time at the location, a required value of the QoS characteristic for the service at the location, a resource for use by the UE 120, a task monitor status, a network monitor status, and a service level agreement (SLA) validity. In some embodiments, a state of the UE 120 is defined as a joint state of two or more of the above features. The joint state may represent an application executed on the UE 120, location, network requirements, path, configurations, and other parameters that describe status and operation of the UE 120.

In some embodiments, a task monitor, which may be included in the network node or may be located in another network node, determines a progress of the task for performance by the UE 120. In some embodiments, the task may include more than one step. Thus, for instance, if the UE 120 such as, e.g., a robot, needs to move between multiple steps of the task to perform the task, a task monitor may monitor the progress of the performance of the task by the UE 120. The task monitor may be a software component executed by a processor of the network node 110, or by a processor of another network node in the wireless communications network 100. Additionally or alternatively, the task monitor may be implemented in hardware, or as a combination of computer-executable instructions and hardware.

In some embodiments, a network monitor, which may be included in the network node 110 or may be located in another network node, may monitor a number of UEs, wireless signal strength, congestion, and other parameters at a particular location in the wireless communications network 100, at a given point in time.

In some embodiments, an SLA validity is based on a target QoS required for performance of the service by the UE 120. If the observed QoS values match or exceed the targets, the SLA validity will be met. In the context of a wireless communications network, an SLA, which may be static or dynamic, is a commitment between two or more parties, such as a consumer and a network service provider that may be, e.g., an operator, an internet service provider (ISP), or an application service provider (ASP).

### Action 307

In some embodiments, the training of the machine learning model, such as the RL model, may be performed using training data acquired, e.g., from the UE 120 or one or more other device in the wireless communications network 100. In some embodiments, training data, which may comprise values of the set of second values of the QoS characteristic for the service, may be acquired from the UE 120 as the UE 120 operates to perform the service.

In some embodiments, the network node 110 receives a value of the set of second values of the QoS characteristic for the service, which value is (i) acquired while the UE is performing the service at a certain location and/or using a certain resource, and (ii) is different from the first value of the QoS characteristic by greater than a threshold value thereby indicating that the certain location and/or the certain resource is not suitable for performance of the service by the UE 120. In such embodiments, the training (action 306) of the RL model comprises taking into consideration the received value of the set of second values of the QoS characteristic such that the reinforcement learning model is trained to avoid allocating locations and/or resources that are similar to the certain location and/or the certain resource that are not suitable for performance of the service by the UE 120.

In some embodiments, a threshold value is incorporated within the reward structure of the RL model. Accordingly, a separate threshold value may not be used for indication that the certain location and/or the certain resource are not suitable for performance of the service by the UE. In such embodiments, the network node 110 may receive the value of the set of second values of the QoS characteristic for the service, in association with information on the certain location and/or resources associated with that value, and along with an indication that the certain location and/or the certain resource are not suitable for performance of the service by the UE. Regardless of the specific way in which the value of the set of second values of the QoS characteristic for the service is received by the network node 110, the RL model will be trained so as to avoid a use of the service at the certain location and/or using the certain resources.

In some embodiments, the difference between the value of the set of second values of the QoS characteristic for the service and the first value of the QoS characteristic is determined by the network node 110. In some embodiments, the difference may be determined by the UE 120, or by both the UE 120 and the network node 110.

In some embodiments, the difference between the value of the set of second values of the QoS characteristic for the service and the first value of the QoS characteristic may be determined based on one or more of the following:
(a) an estimate determined by one or both the UE 120 and the network node 110, when it is expected that the UE 120 will move to a new location and/or resource to perform the service; or
(b) based on history, e.g. based on prior use of the same location and/or resource by the UE 120 or by another UE for performance of the service, such that it may be expected that a QoS value that may be achieved at these location and/or resource is similar to a prior QoS value achieved in the past by the UE 120 or by another UE;
(c) active approach, e.g. as the UE 120 utilizes the new location and/or resource to perform the service, the UE 120 dynamically determines a difference between a currently observed QoS value of a QoS characteristic for the service and a first value of the QoS characteristic for that service; and
(d) a combination of the above approaches.

In some embodiments, when the difference between the value of the set of second values of the QoS characteristic for the service and the first value of the QoS characteristic may be determined based on prior use of a certain location and/or a certain resource, weights may be applied to historical data related to usage of a certain location and/or a certain resource, e.g., higher correlation weights may be applied to recent historical data and lower correlation weights may be applied to less recent historical data. In this way, more recently acquired historical data may be treated as being more informative regarding QoS values which may be achieved at a certain location and/or using a certain resource.

In some embodiments, the threshold value may be a suitable qualitative, quantitative, or a combination thereof value which is used to define how far an observed QoS value for a certain service may deviate from a target QoS value for that service and still be considered an acceptable QoS value. The threshold value may depend on a type of the service, properties of the operating environment in the wireless communications network 100, and other factors. Furthermore, in some embodiments, the threshold value may vary, e.g. based on a time of day, a traffic pattern, a number of UEs in the environment, etc. The threshold value may be dynamically adjustable on one or more of various factors. In some embodiments, the threshold value may be adjusted such that, for example, a different threshold value may be used for the same location at different times of days. As another example, as the number of UEs changes, different threshold value may be used.

When the network node 110 determines that certain observed values of QoS characteristics are not suitable for a given service at a certain location and/or using a certain resource in the wireless communications network 100, the network node 110 may update the information used for training of the RL or another machine learning model, or may otherwise make use of the data obtained from the UE 120. Regardless of the specific way in which the network node 110 processes the information on the observed values of QoS characteristics acquired with respect to the certain location and/or the certain resource, in some embodiments, the network node 110 may strive not to allocate to UEs locations or resources similar to the certain location or the certain resource for performance by the UEs of a similar service. In this way, the UE 120, or another UE, e.g. the UE 121, may avoid a location or service that does not allow the service, or a similar service, be performed at a required QoS.

In some embodiments, the network node 110 may gather information on states, e.g., locations or resources similar to the certain location or the certain resource at which observed values of QoS characteristics are not suitable for a given service, by, e.g. using statistics or service history from the UE or other UEs. The network node 110 may then attempt not to allocate such locations or resources to the UE for the same or similar service.

### Action 308

The network node 110 uses the obtained set of second values and the obtained first value in the machine learning model to determine a value of an operating parameter of the UE 120 for performance of the task by the UE 120. This action involves applying the machine learning model such as e.g. an RL model, which may be trained, e.g. as described above, to one or more of the obtained set of second values of the QoS characteristic, to determine a value of an operating parameter for controlling the UE 120 to perform the task, given the observed values. The control may be automatic, remote, manual, or a combination thereof.

In some embodiments, the operating parameter is associated with any one out of: a location of the UE 120 in the wireless communications network 100, a duration of time at the location, and a resource for use by the UE 120. The location may be a geographical region where a target QoS of one or more services for the task may be met. The location may define a trajectory for the UE 120 to follow in the wireless communications network to perform the task. The duration of time at the location may define for how long the UE 120 can remain at a certain location while performing a service for the task, while maintaining the required QoS, i.e. while having values from the obtained set of second values of the QoS characteristic that match the first value of the QoS characteristic. The resource may be any one or more out of a wireless channel resource, spatial resource, beamforming resource, spectral resource or bandwidth, RAN resource allocation, transport router priority, core virtual machine (VM) resource, etc. In some embodiments, resource may be any one or more out of a GBR, delay critical GBR, non-GBR, or another type of a resource. In some embodiments, the operating parameters may include a duration of time during which the UE 120 may use a certain resource. The operating parameter may be any other parameter that may be used to monitor and control operation of the UE 120 for performance of one or more services of the task.

As used herein, the operating parameter determined using the present method indicates whether or not the UE 120 is to change a current location, resource, or another feature characterizing a current state of the UE 120. For example, the determined operating parameter may be one or more out of a location different from the current location of the UE 120, a duration of the time at the location different from the current location of the UE 120, a duration of time for the UE 120 to remain at the current location, and a resource different from the current resource of the UE 120. As another example, the determined value of the operating parameter is a value that may be used to control the UE 120 as the UE 120 moves and performs certain actions to perform the task in the wireless communications network 100. In this way, values of the operating parameter are determined for performance of the task by the UE 120 so that the target QoS is maintained for the one or more service for the task and thus for the task.

### Action 310

In some embodiments, the wireless communications network 100 includes multiple UEs, such as, e.g. UE 120, 121 as shown in FIG. 1. An example of multiple UE is also shown in FIG. 2. The wireless communications network 100 may include any suitable number of UEs, and the UEs may comprise or may be associated with any type of an autonomous or semi-autonomous devices such as e.g. robots, vehicles, or drones. To avoid conflicts in operations of the multiple devices in a facility, e.g., on a factory floor, or in another setting, in some embodiments, operating parameters are determined for more than one UE. In this way, a planning is carried out for multiple UEs, in a manner that allows allocating locations and/or resources to two or more UEs. Thus, for example, given a certain configuration and other properties of a factory floor, a method in accordance with embodiments of the present disclosure may determine how the UEs are to be controlled for operation on the factory floor such that a required QoS is met for the services their perform. The multiple UEs may be controlled to have trajectories and resource usage which allow avoiding collisions e.g. in complex manufacturing processes, allocating resources without conflicts, and ensuring smooth operation of multiple UEs and devices associated with the UEs.

Accordingly, in some embodiments, the network node 110 further determines a value of the operating parameter for at least one other UE 121 in the wireless communications network 100, wherein the machine learning model, e.g. the RL model, is further taking the value of the operating parameter for the at least one other UE 121 into account.

In some embodiments, the machine learning model may take into account one or more of locations and resources allocated to the other UE 121, while determining locations and/or resources for the UE 120. In some embodiments, the using the obtained set of second values and the obtained first value in the machine learning model to determine the value of the operating parameter of the UE 120 for performance of the task by the UE 120 is performed as part of the determining the value of the operating parameter for the at least one other UE 121. In this way, trajectory paths may be determined for more than one UE, which may be done simultaneously or at different, e.g. alternating, times.

A value of the operating parameter for the at least one other UE 121 in the wireless communications network 100 may be determined in the same or similar manner as described for the UE 120. Accordingly, in some embodiments, the network node obtains a first value of a QoS characteristic for a service that is associated with a task performed by the other UE 121, obtains second values of the QoS characteristic for the service, uses the obtained second values and the obtained first value in a machine learning, e.g. RL, model to determine a value of an operating parameter of the other UE for performance of the task by the UE 121, and transmits an indication of the determined value of the operating parameter for controlling operation of the other UE in the wireless communications network 100 based on the determined value of the operating parameter.

The operating parameter may be associated with any one out of a location of the other UE 121 in the wireless communications network 100, a duration of time at the location, and a resource for use by the other UE 121. Any features or combination thereof described herein in connection with the UE 120 are appliable to determining the value of the operating parameter for the UE 121 as well.

### Action 312

In some embodiments, the network node 110 transmits an indication of the determined value of the operating parameter for controlling operation of the UE 120 in the wireless communications network 100 based on the determined value of the operating parameter.

The indication may be used to instruct the UE 120 to adjust or change its location or position in the wireless communications network 100, resource or resource usage, or otherwise change its operation so as to maintain target QoS values for one or more services for the task.

The network node 110 may transmit the indication of the determined value of the operating parameter to any one out of:
the UE 120;
a component of the network node 110;
a base station;
an operator of the wireless communications network 100;
a location server of the wireless communications network 100;
a controller of a facility, wherein the facility comprises the network node 110 and the UE 120;
a controller of a drone system, wherein the drone system comprises the network node 110 and the UE 120; and
another network node in the wireless communications network 100.

The indication may be transmitted to any entity that controls, at least in part i.e. possibly in combination with one or more of other entities, operation of the UE 120. As described throughout the present disclosure, in some embodiments, controlling the UE may involve controlling location and/or resource type and usage of a device associated with the UE 120, to which the UE 120 provides a connectivity function in the wireless communications network 100. The device may be one or more out of a mobile robot, an autonomous or semi-autonomous vehicle such as e.g. an automated guided vehicle, a drone, a moveable assembly platform, a portable assembly tool, a mobile control panel, equipment, or any other device that communicates with the network node and possibly other UEs in the wireless communications network 100. The indication may thus be sent to any controller device or system capable of controlling actuators, sensors, controllers, and/or other components of the UE 120 during UE operation.

In some embodiments, to maintain target QoS values for a service, the UE 120 may be instructed to move from a current location to a next location e.g. where observed QoS values are expected to closer match the target QoS values than in the current location. In some cases, the UE 120 may be instructed to remain at the current location or to return to a prior location. Additionally or alternatively, the UE 120 may be instructed to switch to another resource, for example, to switch from a licensed channel to an unlicensed channel, or vice versa.

Regardless of the specific way in which the indication of the determined value of the operating parameter is used to control operation of the UE 120, the UE's movements and resource usage may be restricted to those geographical regions and/or resources that ensure that observed QoS values satisfy target QoS values.

In some embodiments, the indication of the determined value of the operating parameter for controlling operation of the UE 120 in the wireless communications network 100 based on the determined value of the operating parameter may be used to any one or more out of:
prevent the UE 120 from providing or receiving the service at a location and/or using a resource at which a value from the set of second values of the QoS characteristic for the service is different from the first value of the QoS characteristic for the service by greater than a first threshold, and
instruct the UE 120 to move to an alternative location and/or an alternative resource at which a value from the set of second values of the QoS characteristic for the service is different from the first value of the QoS characteristic for the service by less than a second threshold.

In some embodiments, the first and second thresholds may be different. In some embodiments, the first and second thresholds may be the same. In some embodiments, the first and second thresholds may be selected based on a service, properties of the environment in which the wireless communications network is deployed, and other factors. The first and second thresholds may indicate that observed QoS values for a service may be determined to match a target QoS value for the service when a difference between the observed QoS values and the target QoS value is less than a certain threshold, e.g. the first or second threshold. If the difference is greater than the certain threshold, a location or resource at which such observed QoS values may be obtained is deemed to be not appropriate or not suitable for that service. For example, a location or resource may be marked as valid or invalid for providing a certain service. It should be appreciated that the location and resource, or a combination thereof, are described by way of example only, as any other operating parameters may be adjusted to ensure proper QoS is maintained for a UE in the wireless communications network.

Furthermore, in some embodiments, two or more levels of suitability of a location or resource for a service may be defined. Accordingly, for example, each location on a floor in a manufacturing or warehouse facility may be associated with a certain level of its suitability for a UE, e.g. the UE 120, to perform, e.g. provide or receive, a certain service at that location. In this way, some locations may be not suitable or invalid, some locations may be valid and more suitable, and some may be marked as valid and most suitable. The levels of suitability may be any suitable quantitative or qualitative values, or combinations thereof.

In some embodiments, a suitability of a certain location or resource for a service may change based on impact of changing traffic and other factors on observed QoS values. For example, in some embodiments, a location may be suitable or not, or may have different levels of suitability based on a time of day, network traffic in that location, presence and a number of UEs at that location, and other factors. In some embodiments, for example, a timing counter may be used by one or both the network node 110 and the UE 120 to determine when observable QoS values on a given resource or location are to be recalculated. For example, the network node 110 or the UE 120, or another component of the wireless communications network 100, may recalculate observable QoS values for the given resource or location when the timing counter expires.

In some embodiments, the UE 120 may be prevented from using certain locations or resources. In some embodiments, the UE 120 may be instructed to perform any one or more out of move to another location, change a resource, or otherwise adjust its operation in order to attain performance of a service at a required or target QoS. The service may be performed as part of an ongoing task or it may be a new service for which resources, locations and other operating parameter values may need to be allocated.

Thus, in some embodiments, to be able to handle operation of the UE 120 in the wireless communications network 100, the network node 110 obtains information on a first value of a QoS characteristic for a service that is associated with a task performed by the UE 120. The first value of the QoS characteristic, as described herein, refers to a required value of the QoS characteristic, which may be assigned to a service or a task. The network node 110 also obtains one or more of second values of the QoS characteristic for the service that is associated with a task performed by the UE 120. The second values of the QoS characteristic may be observed values that are acquired, e.g. as the UE 120 performs the task in the actual operating environment or in a simulation environment, e.g., as part of training of the UE 120 to perform the task, or in a combination of these settings.

In some embodiments, the method of FIG. 3 is performed offline, before the actual operation of the UE 120, e.g. as one or more UEs are being mapped to respective locations and/or resources in the wireless communications network 100, such as, e.g. a floor or other area of a manufacturing facility. In this way, proper locations and/or resources are identified for performance of a task by the UE 120. Thus, a path for the UE in the wireless communications network 100 may be mapped, such that the UE 120 is trained to carry out a task in the regions and using resources that ensure that the task performance meets a required QoS for that task.

In some embodiments, the method of FIG. 3 is performed dynamically in real time, i.e. as the UE 120 operates in the wireless communications network 100 and actually performs the task. In some embodiments, the method is performed in part before the actual operation of the UE 120 and in part during the actual operation of the UE 120. For example, certain operating parameters are determined for the UE 120 prior its operation e.g., in a manufacturing facility, and these parameters may be adjusted dynamically, based on sensor and other measurements acquired during the time when the UE 120 performs a task in the facility, interacts with other UEs, and acquires further information about the operating environment. Regardless of when the method of FIG. 3 is performed, it is used to learn relationships between location- and task-specific requirements to ensure the observed QoS at that location matches the target QoS.

The embodiments described in connection with FIGS. 2 and 3 will now be further discussed and exemplified below. The embodiments below may be combined with any suitable embodiment above.

FIG. 4 illustrates an example of an embodiment of communications in the wireless communications network 100, for performance of a method in accordance with embodiments of the present disclosure. In FIG. 4, the UEs 120, 121 and the network node 110 are shown by way of example only. A suitable component of the network node 110, such as an RL agent, may perform a method in accordance with embodiments of the present disclosure. As shown in FIG. 4, the network node 110, e.g., a gNodeB, may obtain from the UE 120 the first value of the QoS characteristic for the service that is associated with the task performed by the UE 120, shown here as 5QI requirements. For example, in a 5G network, a 5QI identifier and associated values of QoS characteristics may be obtained by the network node 110. As mentioned above, in some embodiments, the network node 110 such as a base station, may obtain the first value of the QoS characteristic of the service from an entity other than the UE 120. A base station may be configured to include information on target QoS values for services performed by subscribers.

As further shown in FIG. 4, the network node 110 may receive a set of second values of the QoS characteristic for the service, e.g. one or more second values, also referred to as observed QoS values. In this example, the second values are shown as location specific QoS information that the network node 110 receives from a network monitor. For example, as the UE 120 is disposed at a certain location, observed QoS values which are observed at that location may be obtained by the network node 110. As shown by a dashed line in FIG. 4, the network monitor may be part of the network node 110, though it may be included in another node or server in the wireless communications network 100. Also, in some embodiments, the observed second values of the QoS characteristic for the service may be obtained by the network node 110 from the UE 120. It should be appreciated that the location specific QoS information is shown in FIG. 4 by way of example only, as information on resources and other features may be acquired additionally or alternatively.

Regardless of how the observed QoS values are acquired by the network node 110, the network node 110 uses the obtained second values and the obtained first value in the RL model, to determine the value of the operating parameter of the UE 120 for performance of the task by the UE 120. The process of applying the RL model to the obtained second values and the obtained first value as shown in FIG. 4 as exploration and location mapping, by way of example. This means that, for example, the RL model explores, for various locations in the wireless communications network 100, whether the target QoS values, defined by the 5QI in this example, can be met. The UE 120 may be mapped to certain locations in an environment in which the wireless communications network 100 is implemented, if it is determined that the target QoS values can be met at those locations.

The application of the RL model to the the obtained second values and the obtained first value results in determining the value of the operating parameter of the UE for performance of the task by the UE 120 for controlling operation of the UE 120. Thus, as shown in FIG. 4, an indication of the value of the operating parameter, shown here by way of example only as 5QI/task constrains on locations, may be transmitted to the UE 120. The task constrains on locations may indicate at which locations, and in some cases for what duration of time, the UE 120 can operate for task performance. The value of the operating parameter may be determined dynamically in real time, as the UE 120 is operating, such that a next location is estimated for the UE in real time. Additionally or alternatively, a sequence of locations may be determined for the UE 120. A combination of online and offline location mapping may be performed in various circumstances. It should be appreciated that, even though the indication of the determined value of the operating parameter is shown in FIG. 4 to be provided to the UE 120, the indication may be provided to another component of the wireless communications network 100 that can control operation of the UE 120 and/or a robotic device or vehicle associated with the UE 120.

Multiple robots may be operating in the wireless communications network 100, and one or more values of operating parameters may be determined for some or all of the robots. Thus, in some embodiments, as further shown in FIG. 4, the network node may also obtain, from the other UE 121, a first value of a QoS characteristic for a service that is associated with a task performed by the other UE 121, shown here as 5QI requirements. A value of an operating parameter of the other UE 121 for performance of the task by the other UE 121 may be determined for the other UE 121 is a manner similar to that described for the UE 120, and further details are not illustrated in FIG. 4 for brevity. It should be appreciated that the network node 110 may determines values of one or more operating parameters for multiple UEs in the wireless communications network 100, and the two UEs 120, 121 are shown in FIG. 4 by way of example.

In some embodiments, a temporal plan may be generated for each of one or more UEs, which specifies how the UE operates in the wireless communications network 100. In some embodiments, temporal plans may be created for different UEs using a certain schedule, such that, e.g. the network node performs location mapping for one UE at a time. Thus, as further shown in FIG. 4, the network node 110 may assign temporal commit times to one or more UEs in the wireless communications network 100, and the temporal commit times may be provided to a planner. The planner may, e.g. schedule policy deployment in sequential manner with execution times considered. More than one planner may operate in the wireless communications network, e.g. if there are overlapping timelines for configuration changes, as long as there are no conflicting constrains. The planner may be located at a base station node or another edge node, and it may be receiving information on UE locations, QoS and other requirements, etc. The planner may provide priority to particular UEs and schedule operations, e.g. in a sequential manner. The scheduling may be implemented so as to ensure time multiplexing when there is contention for resources. In some embodiments, the planner may be a higher-level scheduler, for coordinating one or more RL agents and thereby coordinating operation of multiple UEs.

### Reinforcement Learning

As discussed above, the RL model explores a state space and actions to transition between states, where each state may be defined as a joint state of one or more of a location of the UE 120 in the wireless communications network 100, a duration of time at the location, a required value of the QoS characteristic for the service at the location, a resource for use by the UE 120, a task monitor status, a network monitor status, and an SLA validity. Various other parameter values may be used additionally or alternatively.

In some embodiments, the RL model is solved using an MDP. The MDP may be formulated for an agent with state space S, action space A, with Pₐ(s,s′) representing the probability of action a in state s leading to s′, and Rₐ(s,s′) providing the reward for transitioning from state s to state s′ due to action a. The RL model may be trained using, e.g., a Q-learning algorithm, a temporal difference learning, or another technique.

In one embodiment, as an example, a joint state may be defined as <robot location, task monitor, network monitor state, 5QI requirements, SLA validity>. In this embodiment, examples of the states may be as follows:
<Robot 1_Location A_Task A_5QI 4_SLA Valid>
<Robot 1 Location B Task A 5QI 3 SLA Invalid>

Examples of the actions then may be as follows:
Actions A: Mark Location as valid for 5QI (Priority, Packet Delay, Packet Loss)
   Mark Location as invalid for 5QI (Priority, Packet Delay, Packet Loss)

Each action may be associated with a respective reward. Thus, continuing with this exemplary embodiment, examples of the rewards may be as follows:
Rewards R: Mark Location as valid for 5QI: (SLA_valid, SLA_invalid)=−10
   Mark Location as valid for 5QI: (SLA_valid, SLA_valid)=+5
   Mark Location as invalid for 5Q1:(SLA_valid, SLA_valid)=−5
   Mark Location as invalid for 5Q1:(SLA_invalid, SLA_valid)=+10.

The RL model is trained to optimize a cumulative reward and thereby determine one or more locations or a sequence of locations for the UE to utilize for performance of a task. The RL model may be updated as new data is acquired.

In some embodiments, the RL model or a combination of RL models may be used to plan operation of more than one UE, which may be associated with a device or vehicle, in the wireless communications network. For example, in some embodiments, the methods in accordance with the present disclosure make use of a temporal nature of artificial intelligence (AI) planning processes to schedule resource allocation, location usage, etc. when there are multiple robots trying to, e.g. mark locations on a factory floor or in another facility. Operation of one or more planners (see, e.g. FIG. 4) may be integrated with application of RL processes to account for multiple UEs, each comprising or being associated with a respective robotic vehicle or device collectively referred to as a robot herein, operating in a common space, e.g.:
T1: Robot 1 Task 1 Location11 5Q11<Duration 10>
T1+1: Reinforcement Learning Agent <Robot 1>Configuration <Duration 1>
T1+2: Reinforcement Learning Agent <Robot 2>Configuration <Duration 1>
T1+3: Robot 2 Task 1 Location1 5Q13<Duration 20>

The above is an example of an output of a plan schedule that ensures policy specified for Robot 1 is compatible with policy specified for Robot 2. Each of the Robot 1 and Robot 2 may be or may be associated with, e.g. the UE 120. In some embodiments, priority and scheduling may are performed sequentially so that each of the UEs or robots can complete its tasks. In the above example, the scheduling is performed for Robot 1 and Robot 2, for performance of Task 1. At a certain time (T1), Robot 1 is scheduled to perform Task 1 at a certain location (Location11) for a certain duration of time (Duration 10), so as to meet QoS values associated with a certain 5QI shown as 5QI1. For the next time period (T1+1), the RL agent provides a certain configuration for Robot 1 to perform the task during Duration 1. For the following time period (T1+2), the RL agent provides a certain configuration for Robot 2 to perform the task during Duration 1. For the following time period (T1+3), Robot 2 is scheduled to perform Task 1 at a certain location (Location1) for a certain duration of time (Duration 20), so as to meet QoS values associated with a certain 5QI shown as 5QI3. In this example, all the notations for locations, time periods, and duration of time are used by way of example only. Furthermore, while this example describes configurations for certain locations, in some embodiments, a configuration may be selected for a certain resource, e.g. a spectral resource. For example, continuing with the example above, the UEs or robots may be scheduled to perform a task, such as Task 1 as in this example, using a certain spectral resource, such as, e.g. SpectralResource11 or Spectral Resource1, which represent examples of different spectral resources.

In some embodiments, two or more planners may determine, along with a network node such as e.g. network node 110, values of operating parameters for multiple UEs in parallel, e.g. when there are overlapping timelines for configuration changes.

Furthermore, in some embodiments, machine learning methods other than RL may be used for performing the methods in accordance with embodiments of the present disclosure. For example, in some embodiments, clustering e.g. a K-means clustering, deep learning, regression, and other techniques may be used. In some embodiments, the machine learning model comprises a deep learning model, a regression model, a classification model, or a combination thereof. In some embodiments, RL is combined with deep learning. In some embodiments, non-limiting examples of a machine learning model include a neural network algorithm, a support vector machine algorithm, a Naive Bayes algorithm, a nearest neighbor algorithm, a boosted trees algorithm, a random forest algorithm, a decision tree algorithm, a logistic regression algorithm, a linear model, a linear regression algorithm, or a combination thereof.

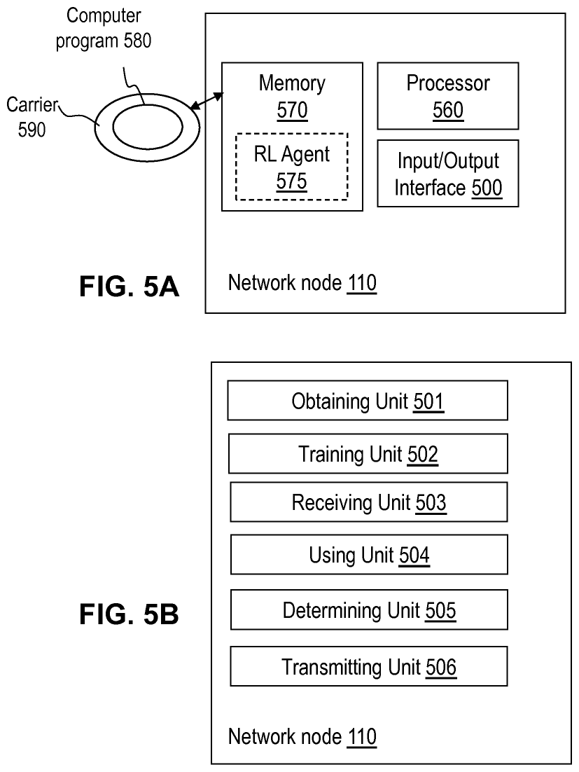

To perform the method actions above, the network node 110 is configured to handle operation of the UE 120, and in some case operation of the UEs 120, 121, in the wireless communications network 100. The network node 110 is described herein in connection with the UE 120, though it should be appreciated that the network node 110 may communicate with more than one UE. The network node 110 may comprise an arrangement depicted in FIGS. 5A and 5B.

As shown in FIG. 5A, the network node 110 may comprise an input and output interface 500 configured to communicate with the UE 120 and other UEs in the wireless communications network 100, e.g. UE 121. The input and output interface 500 may comprise a wireless receiver (not shown) and a wireless transmitter (not shown).

The network node 110 may be configured to, e.g. by means of an obtaining unit 501 in the network node 110, obtain the first value of the QoS characteristic for the service that is associated with the task performed by the UE 120. The first value of the QoS characteristic for the service comprises a target value of the QoS characteristic, and the first value may comprise values for more than one QoS characteristic. In some embodiments, the first value of the QoS characteristic comprises a set of QoS characteristics such as, e.g. priority level, packet delay or packet error rate, etc., associated with a 5QI. The network node 110 may obtain the first value of the QoS characteristic for the service from the UE 120 or from another node in the wireless communications network 100.

In some embodiments, the network node 110 may further be configured to, e.g. by means of the obtaining unit 501 in the network node 110, obtain the set of second values of the QoS characteristic for the service. In some embodiments, the second values may be observed values of the QoS characteristic that are acquired as the UE 120 is performing the task. As an example, the UE 120 may comprise or may be associated with a robot that is moving on a facility, e.g., a factory, floor while performing a task, and the set of second values of a QoS characteristic for one or more services for that task may be acquired as the robot is in operation. The acquired values may change as the robot moves across the facility floor, switches between use of different resources, and/or otherwise changes values of its operating parameters. This may be performed offline, as part of training the UE 120 to operate in a certain environment, or at least some of the second values of the QoS characteristic for the service may be obtained dynamically, in real time. In some embodiments, the second values of the QoS characteristic may be acquired as a result of computational simulation.

The network node 110 may further be configured to, e.g. by means of a training unit in the network node 110, train the RL model. The RL model may be trained using previously acquired data, e.g. previously acquired second values of one or more QoS characteristic for one or more service. In some embodiments, the RL model may additionally be updated as the robot is operating in the real-world environment.

In some embodiments, the network node 110 may further be configured to, e.g. by means of a receiving unit 503 in the network node 110, receive the value of the second values of the QoS characteristic for the service, which value is acquired while the UE is performing the service at a certain location and/or using a certain resource. The value may be (i) acquired while the UE 120 is performing the service at a certain location and/or using a certain resource, and (ii) is different from the first value of the QoS characteristic by greater than a threshold value thereby indicating that the certain location and/or the certain resource is not suitable for performance of the service by the UE 120. In such embodiments, the network node 110 may further be configured to, e.g. by means of the training unit 502, training the reinforcement learning model while taking into consideration the received value of the second values of the QoS characteristic such that the reinforcement learning model is trained to avoid allocating locations and/or resources that are similar to the certain location and/or the certain resource that are not suitable for performance of the service by the UE 120.

The network node 110 may further be configured to, e.g. by means of a using unit in the network node 110, use the set of second values and the first value in the reinforcement learning model to determine the value of the operating parameter of the UE for performance of the task by the UE. The operating parameter may be associated with any one out of: a location of the UE 120 in the wireless communications network 100, a duration of time at the location, and a resource for use by the UE 120.

The network node 110 may further be configured to, e.g. by means of a determining unit 505 in the network node 110, determine a value of the operating parameter for at least one another UE 121 in the wireless communications network 100. The value of the operating parameter of the UE 120 for performance of the task by the UE 120 may be determined as part of the determining the value of the operating parameter for the at least one other UE 121. Thus, in some embodiments, values of operating parameters may be determined for multiple UEs in the wireless communications network 100. For at least some of the multiple UEs, values of operating parameters may be determined in parallel.

Furthermore, in some embodiments, the network node 110 performs, e.g. by means of the using unit 504, the using of the obtained set of second values and the obtained first value in the RL model to determine the value of the operating parameter of the UE 120 for performance of the task by the UE 120, as part of the determining the value of the operating parameter for the at least one other UE 121. In some embodiments, the using unit 504 and the determining unit 505 may be part of the same unit in the network node 110. However, in some embodiments, the using unit 504 and the determining unit 505 may be separate units.

Furthermore, in some embodiments, one or more out of the training unit 502, the receiving unit 503, the using unit 504, and the determining unit 505 may be implemented as part of the same one or more units. The one or more of these units may implement an the RL agent 575 shown in FIG. 5A.

The network node 110 may further be configured to, e.g. by means of a transmitting unit 506 in the network node 110, transmit the indication of the determined value of the operating parameter for controlling operation of the UE in the wireless communications network based on the determined value of the operating parameter. The indication of the determined value of the operating parameter may be transmitted to the UE 120 or to another entity, such as, e.g., any one or more out of a component of the network node 110, a base station if the network node 110 is different from a base station, an operator of the wireless communications network 100, a location server of the wireless communications network 100, a controller of a facility that comprises the network node and the UE 120, controller of a drone system that comprises the network node 110 and the UE 120, or another network node in the wireless communications network 100.

The embodiments herein may be implemented through a respective processor or one or more processors, such as the processor 560 of a processing circuitry in the network node 110 depicted in FIG. 5B, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 570 comprising one or more memory units. The memory 570 comprises instructions executable by the processor in network node 110. The memory 570 is arranged to be used to store e.g. information, indications, data, configurations, and applications to perform the methods herein when being executed in the network node 110. In some embodiments herein, as shown in FIG. 5A, the memory 570 comprises an RL agent 575 for training and applying an RL model in accordance with embodiments of the present disclosure. The RL agent 575 may be executed by the processor 560.

In some embodiments, a computer program 580 comprises instructions, which when executed by the respective at least one processor 560, cause the at least one processor of the network node 110 to perform the actions above.

In some embodiments, a respective carrier 590 comprises the respective computer program 580, wherein the carrier 590 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110. The software and/or firmware, when executed by the respective one or more processors, such as the processors described above, cause the one or more processors to carry out the actions described herein, as performed by network node 110. One or more of the processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

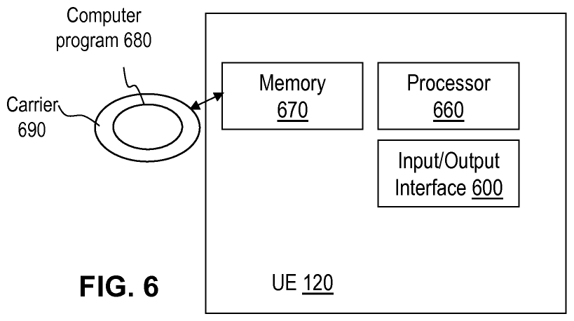

In some embodiments, the UE 120 may comprise an arrangement depicted in FIG. 6. The UE 121 and the UE 122 may have similar arrangements, and their arrangements are thus not described separately herein. The UE 120 may comprise or may be associated with a fully or partially autonomous robot, a robot that operates in collaboration with a human, a drone, a transportation device such as a vehicle, a smart tool, or any other suitable device that forms part of or is associated with the wireless communications network 100 and may communicate with other devices in the wireless communications network 100.

As shown in FIG. 6, the UE 120 may comprise an input and output interface 600 configured to communicate with network nodes such as the network node 110. The input and output interface 600 may comprise a wireless receiver (not shown) and a wireless transmitter (not shown). The UE 120 also comprises a processor or one or more processors, such as the processor 660 of a processing circuitry in the UE 120 depicted in FIG. 6, together with respective computer program code for performing various functions and actions of. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 670 comprising one or more memory units. The memory 670 comprises instructions executable by the processor in UE 120. The memory 670 is arranged to be used to store e.g. information, indications, data, configurations, and applications to perform the methods herein when being executed in the UE 120.

In some embodiments, a computer program 680 comprises instructions, which when executed by the respective at least one processor 660, cause the at least one processor of the UE 120 to perform various actions.

In some embodiments, a respective carrier 690 comprises the respective computer program 680, wherein the carrier 690 is one of an electronic signal, an optical signal, an electromagnetic signal, a magnetic signal, an electric signal, a radio signal, a microwave signal, or a computer-readable storage medium.

The UE 120 may comprise various units (not shown) that may refer to a combination of analog and digital circuits, and/or one or more processors configured with software and/or firmware, e.g. stored in the UE 120, that may be executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

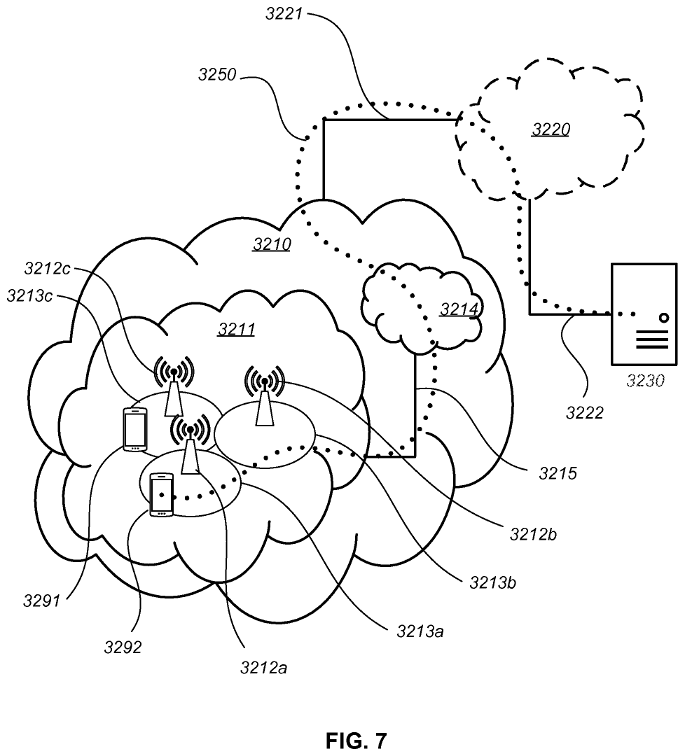

With reference to FIG. 7, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A user equipment (UE) such as a Non-AP STA 3291, e.g. the UE 120 in some embodiments, located in coverage area 3213c is configured to wirelessly connect to, or be paged by, the corresponding base station 3212c. A second UE 3292, such as a Non-AP STA, e.g. the UE 120 in some embodiments, in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE towards the host computer 3230.

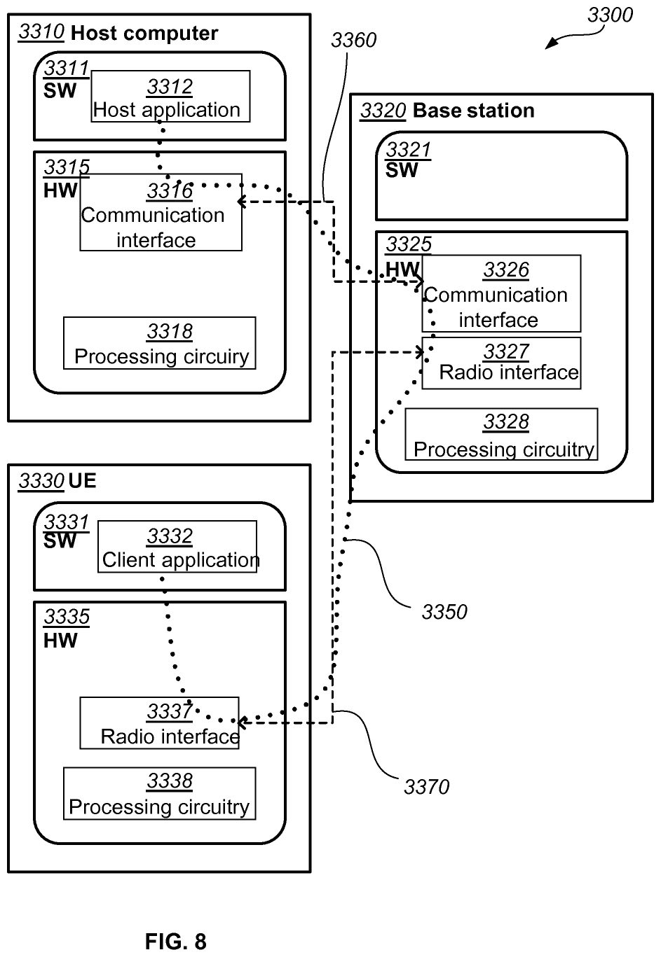

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

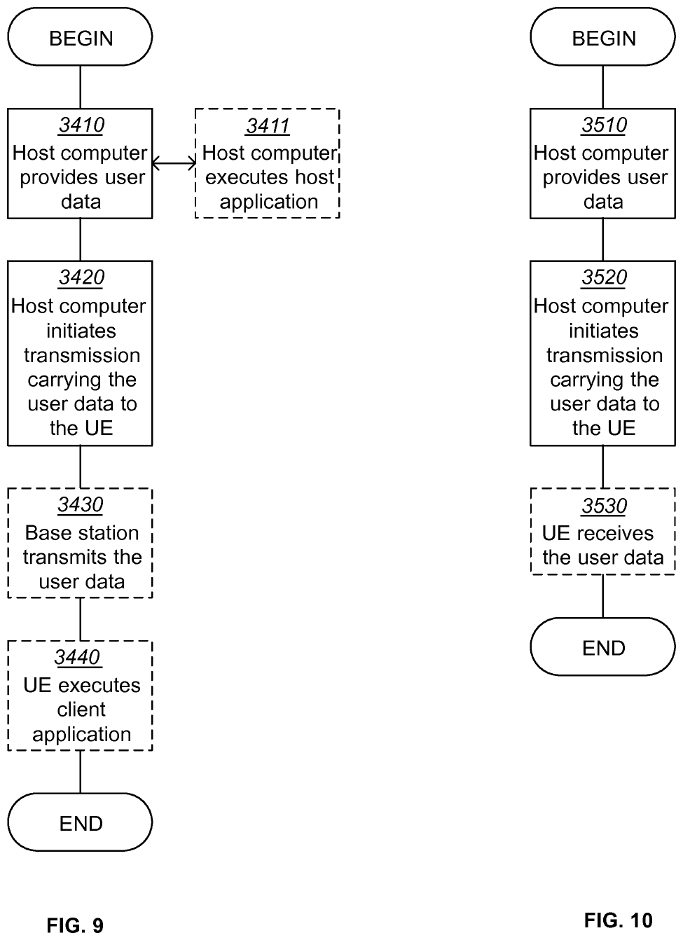

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 7. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

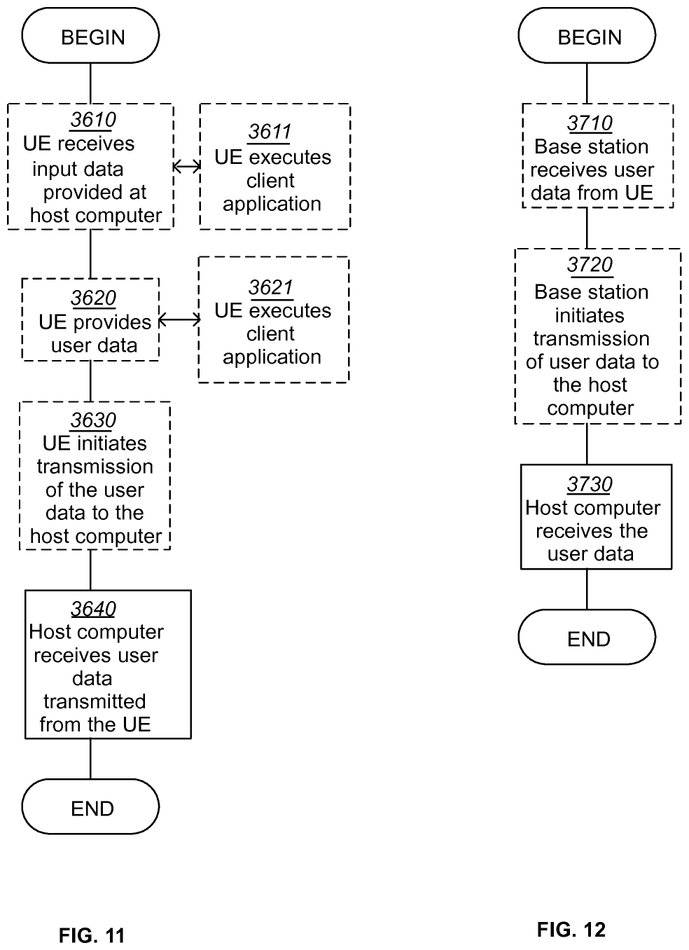

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a network node for handling operation of a User Equipment, UE, in a wireless communications network, the method comprising:
obtaining a first value of a quality of service, QoS, characteristic for a service that is associated with a task performed by the UE;
obtaining a set of second values of the QoS characteristic for the service;
using the obtained set of second values and the obtained first value in a machine learning model to determine a value of an operating parameter of the UE for performance of the task by the UE; and
transmitting an indication of the determined value of the operating parameter for controlling operation of the UE in the wireless communications network based on the determined value of the operating parameter.

2. The method according to claim 1, wherein the operating parameter is associated with any one out of: a location of the UE in the wireless communications network, a duration of time at the location, and a resource for use by the UE.

3. The method according to claim 1, wherein the QoS characteristic comprises one or more out of a packet priority, a packet error rate, a packet delay, a bit rate guarantee, an applied periodicity, an allowed data for a packet, a packet delay variation, a minimum burst value, a maximum burst value, an average burst value, n-th delay moment, n-th moment of arrival rate, packet arrival distribution, delay variance, arrival variance, and packet volume distribution.

4. The method according to claim 1, wherein the machine learning model comprises a reinforcement learning model, and the method further comprises:
training the reinforcement learning model by applying a reinforcement learning algorithm to a set of states of the UE and a set of actions of the UE to be taken by the UE to transition between states of the set of states, wherein:
each state from the set of states of the UE is associated with a corresponding operating parameter of the UE;
each action from the set of actions of the UE is associated with a corresponding reward value; and
the reinforcement learning model is trained to identify whether the UE is to take an action from the set of actions of the UE, to transition from a first state from the set of states of the UE to a second state from the set of states of the UE when an observed value for the QoS characteristic for the service at the second state is closer or closest to the first value of the QoS characteristic as compared to an observed value for the QoS characteristic for the service at the first state.

5. The method according to claim 4, wherein a state of the set of states of the UE comprises one or more of the location of the UE in the wireless communications network, a duration of time at the location, a required value of the QoS characteristic for the service at the location, a resource for use by the UE, a task monitor status, a network monitor status, and a service level agreement validity.

6. The method according to claim 4, further comprising:
receiving a value of the set of second values of the QoS characteristic for the service, which value is acquired while the UE is one or both performing the service at a certain location and using a certain resource, and is different from the first value of the QoS characteristic by greater than a threshold value thereby indicating that one or both of the certain location and the certain resource is not suitable for performance of the service by the UE, wherein:
training the reinforcement learning model comprises taking into consideration the received value of the set of second values of the QoS characteristic such that the reinforcement learning model is trained to avoid allocating one or both locations and resources that are similar to one or both of the certain location and the certain resource that are not suitable for performance of the service by the UE.

7. The method according to claim 1, further comprising:
determining a value of the operating parameter for at least one other UE in the wireless communications network, wherein:
the machine learning model is further taking the value of the operating parameter for the at least one other UE into account.

8. The method according to claim 2, wherein the indication of the determined value of the operating parameter for controlling operation of the UE in the wireless communications network based on the determined value of the operating parameter is used to any one or more out of:
prevent the UE from one or both providing or receiving the service at a location and using a resource at which a value from the set of second values of the QoS characteristic for the service is different from the first value of the QoS characteristic for the service by greater than a threshold, and
instruct the UE to move to one or both an alternative location and an alternative resource at which a value from the set of second values of the QoS characteristic for the service is different from the first value of the QoS characteristic for the service by less than a threshold.

9. A computer storage medium storing a computer program comprising instructions, which, when executed by at least one processor, cause the at least one processor to perform a method, the method comprising:
obtaining a first value of a quality of service, QoS, characteristic for a service that is associated with a task performed by a user equipment, UE;
obtaining a set of second values of the QoS characteristic for the service;
using the obtained set of second values and the obtained first value in a machine learning model to determine a value of an operating parameter of the UE for performance of the task by the UE; and
transmit an indication of the determined value of the operating parameter for controlling operation of the UE in the wireless communications network based on the determined value of the operating parameter.

10. (canceled)

11. A network node configured for handling operation of a User Equipment, UE, in a wireless communications network, the network node being configured to:
obtain a first value of a quality of service, QoS, characteristic for a service that is associated with a task performed by the UE;
obtain a set of second values of the QoS characteristic for the service;
use the obtained set of second values and the obtained first value in a machine learning model to determine a value of an operating parameter of the UE for performance of the task by the UE; and
transmit an indication of the determined value of the operating parameter for controlling operation of the UE in the wireless communications network based on the determined value of the operating parameter.

12. The network node according to claim 11, wherein the operating parameter is associated with any one out of: a location of the UE in the wireless communications network, a duration of time at the location, and a resource for use by the UE.

13. The network node according to claim 11, wherein the QoS characteristic comprises one or more out of a packet priority, a packet error rate, a packet delay, a bit rate guarantee, an applied periodicity, an allowed data for a packet, a packet delay variation, a minimum burst value, a maximum burst value, an average burst value, n-th delay moment, n-th moment of arrival rate, packet arrival distribution, delay variance, arrival variance, and packet volume distribution.

14. The network node according to claim 11, wherein the machine learning model comprises a reinforcement learning model, and the network node is further configured to:
train the reinforcement learning model by applying a reinforcement learning algorithm to a set of states of the UE and a set of actions of the UE to be taken by the UE to transition between states of the set of states, wherein:
each state from the set of states of the UE is associated with a corresponding operating parameter of the UE;
each action from the set of actions of the UE is associated with a corresponding reward value; and
the reinforcement learning model is trained to identify whether the UE is to take an action from the set of actions of the UE, to transition from a first state from the set of states of the UE to a second state from the set of states of the UE when an observed value for the QoS characteristic for the service at the second state is closer or closest to the first value of the QoS characteristic as compared to an observed value for the QoS characteristic for the service at the first state.

15. The network node according to claim 14, wherein a state of the set of states of the UE comprises one or more of the location of the UE in the wireless communications network, a duration of time at the location, a required value of the QoS characteristic for the service at the location, a resource for use by the UE, a task monitor status, a network monitor status, and a service level agreement (SLA) validity.

16. The network node according to claim 14, wherein the network node is further configured to:
receive a value of the set of second values of the QoS characteristic for the service, which value is (i) acquired while the UE is performing the service at one or both of a certain location and using a certain resource, and (ii) is different from the first value of the QoS characteristic by greater than a threshold value thereby indicating that one or both of the certain location and the certain resource is not suitable for performance of the service by the UE, wherein;
training the reinforcement learning model comprises taking into consideration the received value of the set of second values of the QoS characteristic such that the reinforcement learning model is trained to avoid allocating one or both locations and resources that are similar to one or both of the certain location and the certain resource that are not suitable for performance of the service by the UE.

17. The network node according to claim 11, wherein the network node is further configured to:
determine a value of the operating parameter for at least one other UE in the wireless communications network, wherein:
the machine learning model is further taking the value of the operating parameter for the at least one other UE into account.

18. The network node according to claim 12, wherein the indication of the determined value of the operating parameter for controlling operation of the UE in the wireless communications network based on the determined value of the operating parameter is used to any one or more out of:
prevent the UE from one or both providing or receiving the service at a location and using a resource at which a value from the set of second values of the QoS characteristic for the service is different from the first value of the QoS characteristic for the service by greater than a threshold; and
instruct the UE to move to one or both of an alternative location and an alternative resource at which a value from the set of second values of the QoS characteristic for the service is different from the first value of the QoS characteristic for the service by less than a threshold.

19. The method according to claim 2, wherein the QoS characteristic comprises one or more out of a packet priority, a packet error rate, a packet delay, a bit rate guarantee, an applied periodicity, an allowed data for a packet, a packet delay variation, a minimum burst value, a maximum burst value, an average burst value, n-th delay moment, n-th moment of arrival rate, packet arrival distribution, delay variance, arrival variance, and packet volume distribution.

20. The method according to claim 2, wherein the machine learning model comprises a reinforcement learning model, and the method further comprises:
training the reinforcement learning model by applying a reinforcement learning algorithm to a set of states of the UE and a set of actions of the UE to be taken by the UE to transition between states of the set of states, wherein:
each state from the set of states of the UE is associated with a corresponding operating parameter of the UE;
each action from the set of actions of the UE is associated with a corresponding reward value; and
the reinforcement learning model is trained to identify whether the UE is to take an action from the set of actions of the UE, to transition from a first state from the set of states of the UE to a second state from the set of states of the UE when an observed value for the QoS characteristic for the service at the second state is closer or closest to the first value of the QoS characteristic as compared to an observed value for the QoS characteristic for the service at the first state.

21. The method according to claim 20, wherein a state of the set of states of the UE comprises one or more of the location of the UE in the wireless communications network, a duration of time at the location, a required value of the QoS characteristic for the service at the location, a resource for use by the UE, a task monitor status, a network monitor status, and a service level agreement (SLA) validity.
